(19) United States
(12) Patent Application Publication
(10) Pub. No.: US 2013/0313343 A1
(43) Pub. Date: Nov. 28, 2013

(54) PLASTIC MATERIAL SEPARATION SYSTEM AND METHOD

(71) Applicant: Lenew Holdings, Inc., Springfield, MI (US)

(72) Inventor: Levi New, Kalamazoo, MI (US)

(21) Appl. No.: 13/902,056

(22) Filed: May 24, 2013

Related U.S. Application Data
(60) Provisional application No. 61/651,959, filed on May 25, 2012.

(51) Int. Cl. B02C 19/06; B02C 23/08; B02C 19/18; F26B 17/10

(52) U.S. Cl. CPC B02C 19/06; F26B 17/103; B02C 23/08; B02C 19/18
USPC 241/1; 209/3.1; 241/38

(57) ABSTRACT

A system and process for separating plastic material from aggregate material. The system and process may utilize airflow through a venturi to dry the plastic and aggregate materials. The plastic particles may then be electrically charged and collected by a grounded drum. In some instances, the separated plastic may then be further processed, for example to produce energy sources.

### RELATED APPLICATION

This application claims priority to U.S. Patent Application Ser. No. 61/651,959 filed on May 25, 2012 and entitled “Plastic Material Separation System and Method.”

### TECHNICAL FIELD

The present disclosure relates generally to systems, methods, techniques, and processes for separating plastic materials from aggregate compositions, for example municipal solid waste. More specifically, this disclosure relates to plastic material separation through use of a device or system that may include a venturi and/or a charging grid.

### BRIEF DESCRIPTION OF THE DRAWINGS

The embodiments disclosed herein will become more fully apparent from the following description and appended claims, taken in conjunction with the accompanying drawings. These drawings depict typical embodiments, which will be described with additional specificity and detail.

FIG. 1 is a side view of a portion of a system for separating plastic materials.

FIG. 2 is a top view of the portion of a system of FIG. 1.

FIG. 3 is a schematic cross-sectional view of a portion of a system for separating plastic materials.

FIG. 4 is a schematic view of a system for separating plastic materials.

FIG. 5 is a flow chart that schematically represents a system and method of plastic material separation.

FIG. 6 is a flow chart illustrating a method of plastic material separation.

### DETAILED DESCRIPTION

Aggregate compositions of materials may include plastic material. For example, municipal solid waste may be composed of household garbage that includes plastic bottles, paper, cardboard, milk containers, plastic water bottles, and the like. In some instances, this waste may simply be delivered to a landfill, without separating particular components of the aggregate composition. In other instances, particular components of the aggregate composition, for example plastic, may be sorted out for recycling or other processing. For instance, plastic material reclaimed from municipal solid waste may be further processed to create energy sources, such as synthesis gas, diesel fuel, or electrical energy.

A plastic material separation system may utilize a venturi to process aggregate material suspended in an airflow. The interaction of the aggregate material with shock waves and/or pressure changes within the venturi may pulverize portions of the material. A system or method that utilizes a venturi to process aggregate waste may be configured to pulverize, dry, and/or impart a charge to the resulting particles.

It will be readily understood that the components of the embodiments, as generally described and illustrated in the figures herein, could be arranged and designed in a wide variety of different configurations. Thus, the following more detailed description of various embodiments, as represented in the figures, is not intended to limit the scope of the disclosure but is merely representative of the various embodiments. The various aspects of the embodiments presented in the figures are not necessarily drawn to scale, unless specifically indicated.

The phrases “coupled to” and “in communication with” refer to any form of interaction between two or more entities, including mechanical, electrical, magnetic, electromagnetic, fluid, and thermal interaction. Two components may be coupled to each other even though they are not in direct contact with each other. For example, two components may be coupled to each other through an intermediate component.

As used herein, “aggregate composition,” “aggregate waste,” or “aggregate material” refers to any collection of materials prior to processing as described herein. For example, municipal solid waste comprising plastic items, paper items, metal items, and/or other waste is an aggregate composition. It will be appreciated by those of skill in the art having the benefit of this disclosure that the methods and processes described herein may be used to sort and separate plastic or other materials from any aggregate composition; though many of the examples and descriptions herein may refer to municipal solid waste, the current disclosure is relevant to any aggregate composition.

The “longitudinal” direction of a tube or pipe refers to a direction along the center axis of the tube or pipe.

As used herein, a “venturi” refers to a length of tube or pipe that transitions from a first diameter to a second diameter that is smaller than the first, and then to a third diameter that is larger than the second. The transitions may take place evenly over a longitudinal length of the venturi. Further, longitudinal sections of a venturi, for example the center section, may have substantially constant diameters.

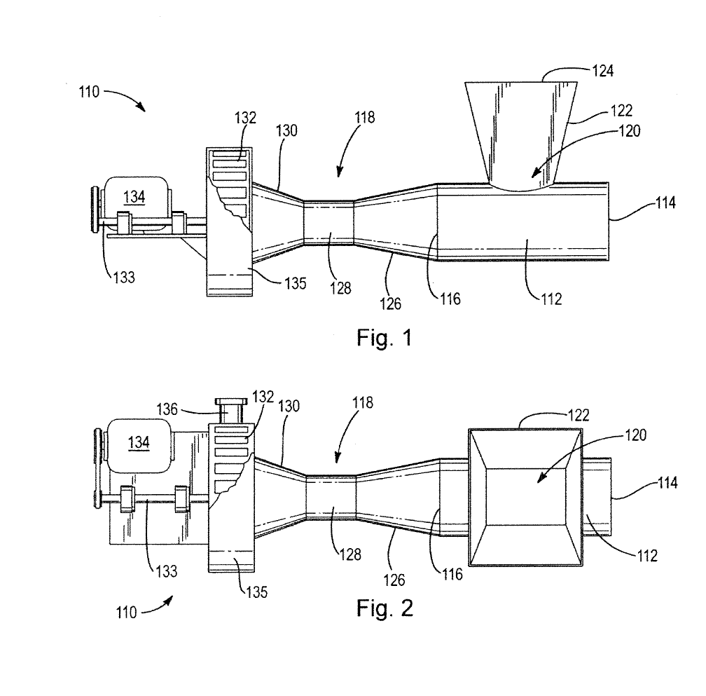

FIG. 1 is a side view of a portion of one embodiment of a pulverization system for use in separating plastic materials, and FIG. 2 is a top view of the pulverization system of FIG. 1. As illustrated in FIGS. 1 and 2, a system for separating plastic materials from aggregate compositions may include a venturi portion 110. The venturi portion 110 itself may also include an inlet tube 112. The inlet tube 112 may define a first end 114, communicating with free space, and an opposing second end 116, which may be coupled to a venturi 118. Although reference is made herein to tubes and pipes, all such elements may have circular, rectangular, hexagonal, and/or other cross-sectional shapes.

The inlet tube 112 may have a length, between its first end 114 and its second end 116, in which material may accelerate before entering the venturi 118. In some embodiments, the system may be configured such that airflow enters the inlet tube 112 at the first end 114. In some embodiments, a filter (not shown) may be placed such that it prevents introduction of foreign particles into the first end 114 of the inlet tube 112. Though the inlet tube 112 has a substantially constant diameter along its length in the illustrated embodiment, this may not be the case in all embodiments.

The inlet tube 112 may further include an elongated opening 120. In the illustrated embodiment, the elongated opening 120 is located on an upper portion of the inlet tube 112. The elongated opening 120 may be in communication with an open lower end of a hopper 122. The hopper 122 may also have an open upper end 124 configured to receive material such as aggregate waste. In certain embodiments, the system may not include a hopper 122. In such embodiments, material such as aggregate waste may simply be inserted into the elongated opening 120 by any method known in the art.

In some embodiments, material may be fed into the inlet tube 112, for example by means of a screw auger (not shown). A screw auger may be used in connection with a hopper 122 or without a hopper 122. In some embodiments, a screw auger may be used to control the feed rate of the aggregate material into the inlet tube 112. Other components, such as a conveyor belt (not shown), may be used to transport aggregate material to the inlet tube 112, and may or may not be used in connection with a screw auger and/or a hopper 122.

The venturi 118 may include a converging portion 126 coupled to the inlet tube 112. The converging portion 126 may progressively reduce in diameter from that of the inlet tube 112. The venturi 118 may also include a throat 128, which may maintain a substantially constant diameter along its length. The throat 128 diameter may be smaller than the diameter of the inlet tube 112. Further, the venturi 118 may also include a diverging portion 130, which may progressively increase in diameter along a length of the venturi in the direction of the airflow. The diverging portion 130 may be coupled to the throat 128 by casting, screw threads, or other known methods. The converging portion 126 may be longer in the longitudinal direction than the diverging portion 130, as illustrated.

The venturi 118 may be in communication with an airflow generator 132 that creates airflow along a path from the first end 114, through the inlet tube 112, through the venturi 118, to the airflow generator or air turbine 132. The velocity of the generated airflow may range from about 100 mph to approximately Mach 1 to supersonic. Due to the geometry of the system, the airflow velocity may be greater in the venturi 118 than in the inlet tube 112. The airflow generator 132 may be embodied as a fan, an impeller, a turbine, a hybrid of a turbine and a fan, a pneumatic suction system, or another suitable device for generating airflow, including devices configured to generate high-speed airflow.

The airflow generator 132 may be driven by a drive motor 134. It is within the scope of this disclosure to use any number of motor designs or configurations. The drive motor 134 may be coupled to an axle 133 using any known method. The axle 133 may also engage the airflow generator 132 to power rotation. In some embodiments, the axle 133 may comprise a transmission system, including gears. The horsepower of a suitable drive motor 134 may vary significantly, such as from 15 hp to 1,000 hp, and may depend on the nature of the material to be treated, the desired material flow rate, the dimensions of the system, and the size of the airflow generator 132. The ranges disclosed above, as well as ranges for other variables disclosed at other points herein, are for illustrative purposes; it is within the scope of this disclosure to modify the system, for example to scale the system up or down.

The airflow generator 132 may include a plurality of radially extending blades that rotate to generate high-speed airflow. Further, the airflow generator 132 may be disposed within a housing 135, which may include a housing outlet 136 providing an exit for air flowing through the system. The housing 135 may be coupled to the venturi 118 and may have a housing input aperture (not shown) that allows communication between the venturi 118 and the interior of the housing 135. The blades may define radially extending flow passages through which air may pass to the housing outlet 136. In some embodiments, the processed material may exit the housing 135 with the airflow leaving the housing 135.

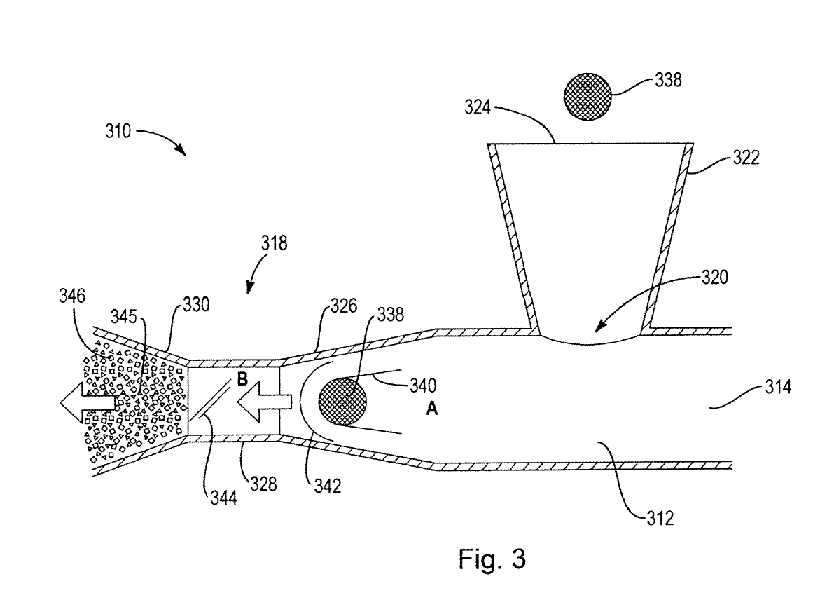

FIG. 3 is a schematic cross-sectional view of the venturi portion 310 of another embodiment of a system for separating plastic materials. In certain respects, venturi portion 310 can resemble components of the venturi portion 110 described in connection with FIGS. 1 and 2 above. It will be appreciated by those of ordinary skill in the art having the benefit of this disclosure that all the illustrated embodiments have analogous features. Accordingly, like features are designated with similar reference numerals, with the leading digits incremented. For instance, the venturi in FIGS. 1 and 2 is designated as 118, and an analogous venturi is designated as 318 in FIG. 3. Relevant disclosures set forth above regarding similarly identified features thus may not be repeated hereafter. Moreover, specific features of the plastic material separation system and method, as well as related components and/or steps, shown in FIGS. 1 and 2 may not be shown or identified by reference numerals in the subsequent figures or specifically discussed in the written description that follows. However, such features may clearly be the same, or substantially the same, as features depicted in other embodiments and/or described with respect to such embodiments. Any suitable combination of the features, and variations of the same, described with respect to the system and components illustrated in FIGS. 1 and 2 can be employed with the system and components of FIG. 3, and vice versa. This pattern of disclosure applies equally to further embodiments depicted in subsequent figures and described hereafter.

FIG. 3 illustrates one embodiment of the operation of a venturi 318 during the processing of aggregate material, such as aggregate waste particles 338. As further described below, aggregate waste particles 338 may first be shredded or otherwise preprocessed in some embodiments. In the illustrated embodiment, the aggregate waste particles 338 are introduced into the inlet tube 312 through the upper end 324 of a hopper 322 and elongated opening 320. Prior to introduction of the aggregate waste particles 338, the airflow generator (not shown) may be utilized to create an airflow within the venturi portion 310, traveling from the first end 314 of the inlet tube 312 through the venturi 318, as indicated by the arrow in FIG. 3. The airflow velocity may substantially accelerate within the venturi 318. The aggregate waste particles 338 may be propelled by the airflow from the inlet tube 312 into the venturi 318. The system may be designed such that the aggregate waste particles 338 are smaller than the interior diameter of the inlet tube 312; thus a gap may be present between the inner edges of the inlet tube 312 and the aggregate waste particles 338 when the aggregate waste particles 338 are disposed within the inlet tube 312.

As the aggregate waste particles 338 enter the converging portion 326, the gap may become narrower such that the aggregate waste particles 338 eventually cause a substantial reduction in the cross-sectional area of the converging portion 326 through which air can flow. A recompression shock wave 340 may trail rearwardly from the aggregate waste particles 338, and a bow shock wave 342 may build up ahead of the aggregate waste particles 338. Where the converging portion 326 merges with the throat 328, there may also be a standing shock wave 344. The action of these shock waves 340, 342, and 344 may tend to pulverize and/or deform portions of the aggregate waste particles 338. Furthermore, processing in venturi portion 310 as described may also dry portions of the aggregate waste particles 338 and/or impart an electrical charge to the particles. In some embodiments, processing through the venturi portion 310 may result in some level of separation between individual components of the aggregate waste, due to the drying action of the airflow as well as the tendency of the shock waves to break up clumps of material. Thus, in FIG. 3, plastic particles 345 and other particles 346 are shown continuing through the diverging portion 330 of the venturi 318 into the airflow generator (not shown). Though the individual particles 345, 346 may appear smaller than the aggregate waste particles 338, processing through the venturi portion 310 may or may not actually reduce the size of the particles, and may or may not break up clumps of aggregate material.

In some embodiments, the processing of the aggregate waste particles 338 may be affected by the speed or volume of airflow through the venturi 318. Thus, in some instances, parameters such as inlet tube 312 diameter, throat 328 diameter, and airflow velocity may be configured to process the aggregate waste particles 338 in a desired manner or to control the properties (such as particle size and/or moisture content) of the processed particles 345, 346.

Alternative embodiments of the systems shown in FIGS. 1-3 may also be utilized within the scope of the present disclosure. Such systems are disclosed in U.S. Pat. Nos. 6,722,594, 6,978953, 7,059,550, 7040,557, 7,137,580, 7,374,113, 7,429,008, 7,500,830, 7,909,577, and 8,057,739 which are incorporated herein by reference.

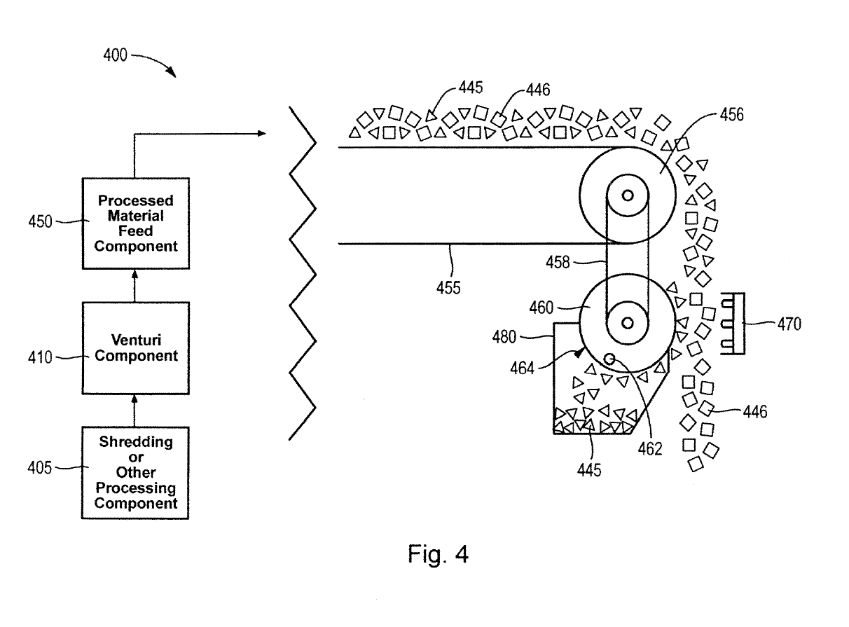

FIG. 4 is a schematic view of a system 400 for separating plastic material from an aggregate composition. The three boxes on the left represent certain components of the system 400, while the right portion schematically illustrates a portion of the system 400.

In some embodiments, aggregate compositions, such as municipal solid waste, may first be processed by a shredding or other preprocessing component 405. In some embodiments, the aggregate composition may be shredded such that the resultant particles are smaller than a particular size, for example four inches, three inches, two inches, or one inch. Material shredding may be accomplished by any conventional shredding mechanism.

The shredded aggregate composition may then be fed into a venturi component 410 such as those described in connection with the systems of FIGS. 1, 2, and/or 3. It will be appreciated by those of skill in the art having the benefit of this disclosure that the aggregate composition may be shredded such that it is configured to be processed as desired within the venturi component 410. Thus, the desirable size of the shredded particles may depend on the size of venturi utilized. The entire disclosed system may be scaled up or down from any of the exemplary values disclosed herein.

In some embodiments, the shredding or preprocessing component 405 may be configured to reduce the size of items within the aggregate composition, allowing the items to be further processed by the venturi component 410 of the system 400. For example, milk jugs, bottles, boxes, or other items that may comprise municipal solid waste may be shredded to a desirable size before being processed in the venturi component 410. In other embodiments, an aggregate composition may be fed directly into the venturi component 410 without preprocessing. As noted above, a screw auger may be utilized to control the feed rate of the shredded material into the venturi component 410. A screw auger may also be used in connection with another feed device, such as a conveyor belt, which may be configured to transport the shredded material from the shredding or preprocessing component 405 to the venturi component 410, and may also be configured to regulate and control the volume of material that reaches the venturi component 410.

As described above in connection with FIGS. 1-3, the venturi component 410 may be configured to dry the shredded aggregate composition particles. In some embodiments, the venturi component 410 may also be configured to break up clumps of the material, deform portions of the material, and/or impart an electrical charge to particles of the material. In some embodiments, certain materials (for example, plastic) may tend to leave the venturi with an electrical charge due to the movement and drying of the particles. In other embodiments, the particles may be charged at a later step in the process, and the drying of the particles by the venturi may aid in the later charging of the particles.

Material processed by the venturi component 410 may then be transported for further processing by any conveyor or feed component 450. The feed component 450 may be configured to control the feed rate and/or volume of material transported.

On the right side of FIG. 4, individual plastic particles 445 and other particles 446 are shown on a conveyor belt 455. The conveyor belt 455 may be part of the same feed component 450 that moves material from the venturi component 410, or it may be a separate component. In the embodiment of FIG. 4, the particles 445, 446 have been processed by the shredding or preprocessing component 405 and the venturi component 410. The conveyor belt 455 may be a high-speed conveyor belt.

The conveyor belt 455 may be configured to transport the particles 445, 446 such that the particles 445, 446 pass proximate to a charging grid 470 and a grounded collection component 460. In the illustrated embodiment, the grounded collection component 460 includes a drum. The drum 460 may comprise a cylindrical workpiece configured to rotate and collect plastic particles 445 on its exterior surface during rotation. The size and dimensions of the drum 460 may vary as needed to optimize collection performance. In an alternative embodiment, the grounded collection component 460 includes a conveyor belt which provides a moving surface to collect plastic particles 445. Utilization of the conveyor belt is similar to use of the drum 460.

In the illustrated embodiment, the particles 445, 446 fall off the end of the conveyor belt 455, and the drum 460 and charging grid 470 are positioned such that the particles 445, 446 fall between them. As can be appreciated, the alignment of the drum 460 and the charging grid 470 may vary as needed and do not need to be necessarily placed at the same height.

The charging grid 470 may be configured to electrically energize the plastic particles 445 but not the other particles 446. In some embodiments, the charging grid 470 may be configured to create an energized field such that plastic particles 445 passing through the field are charged while other particles 446 are not.

The drum 460 may be grounded, such that the charged plastic particles 445 are attracted to the drum 460 while the non-charged other particles 446 simply fall past the drum 460. Once the plastic particles 445 are thus separated from the other particles 446, the other particles 446 may be collected for further processing or disposal.

The drum 460 may be coupled to the conveyor belt 455 by a chain or belt 458 or other component configured to match the rotational speed of the drum 460 with that of the conveyor belt 455. This coupling may be configured to ensure the drum 460 has sufficient capacity to attract and adhere to all the charged plastic particles 445 that pass by the drum 460. Depending on the size and/or diameter of the drum 460, the composition of the particles 445, 446, and similar factors, it may be desirable for the drum 460 to rotate faster or slower with respect to the conveyor belt 455. In such instances, an increase or reduction in rotational speed may be accomplished by different sized sprockets coupled to the conveyor roller 456 and the drum 460, gears, or similar components. The coupling of the drum 460 to the conveyor roller 456 may be configured such that the two components maintain the same relative speed (i.e., the drum 460 speeds up when the conveyor roller 456 speeds up), even if the components do not turn at the same rate.

The drum 460 may further be used in connection with one or more components configured to remove the charged plastic particles 445 from the drum 460. For example, an air nozzle 462 or manifold may be configured to direct a stream of air onto the drum 460 such that the stream of air dislodges the charged plastic particles 445 from the drum 460. In some instances, the drum 460 may be perforated and the airstream and air nozzle 462 configured such that the airstream is directed from the inside of the drum 460 and blows the plastic particles 445 off the drum 460 from the inside.

In other embodiments, a wiper blade 464 may be configured to contact and remove charged plastic particles 445 from the drum 460. In some embodiments, both an air nozzle 462 and a wiper blade 464 may be used in connection with the same drum 460. Other methods of removing particles from the drum 460, such as brushes and/or fans, may also be employed.

The wiper blade 464, air nozzle 462, or other particle removing components may be configured such that the plastic particles 445 are collected in a collection hopper 480 once dislodged from the drum 460. The collection hopper 480 may be a sufficient distance from the drum 460 such that the plastic particles 445 remain in the collection hopper 480 and do not re-adhere to the drum 460 due to the charge on the particles. Also, in some embodiments, the charge may tend to dissipate when the plastic particles 445 are no longer near the charging grid 470.

Plastic particles 445 may then be collected for further processing, for example for use in producing energy sources such as synthesis gas, diesel fuel, or electrical energy. The plastic particles 445 may also be recycled for other uses.

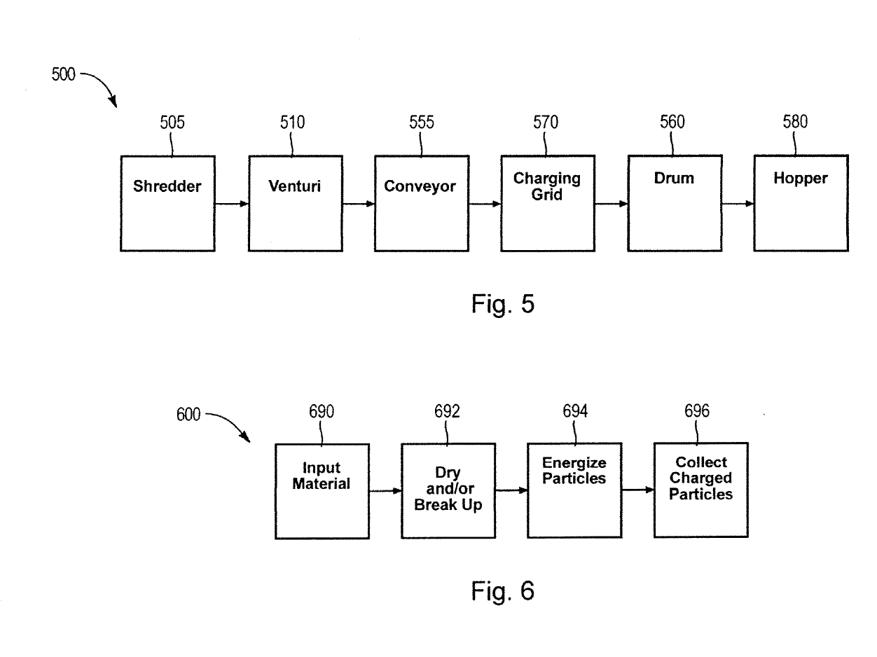

FIG. 5 is a flow chart that schematically represents a system and method of plastic material separation 500. As shown in FIG. 5, and analogous to the disclosure related to the other figures, unprocessed aggregate material may first be processed by a shredder 505 and then fed into a venturi 510. Once the material is dried and otherwise processed by the venturi 510, a conveyor 555 may transport the material to a charging grid 570, which imparts a charge to select particles within the material, for example plastic particles. A grounded drum 560 may be configured to collect the charged particles, which are then removed into a hopper 580 for further processing or recycling.

It is within the scope of this disclosure to add steps and components at any point in the systems and/or processes described in connection with FIG. 5 or any of the other figures. For example, in some embodiments, the plastic particles may be further sorted or processed after they are collected.

FIG. 6 is a flow chart illustrating a method of plastic material separation 600. Again, as described in connection with the other figures, input material 690, such as aggregate material, is dried or broken up 692, and then select particles are energized 694. The energized particles are then collected 696 for further use or processing. Again, steps such as preprocessing, postprocessing, and/or other steps performed during the method may be added to method 600.

Without further elaboration, it is believed that one skilled in the art can use the preceding description to utilize the present disclosure to its fullest extent. The examples and embodiments disclosed herein are to be construed as merely illustrative and exemplary, and not as a limitation of the scope of the present disclosure. It will be apparent to those having skill in the art that changes may be made to the details of the above-described embodiments without departing from the underlying principles of the disclosure herein. It is intended that the scope of the invention be defined by the claims appended hereto and their equivalents.

1. A method of separating plastic from aggregate waste material, comprising:
introducing the aggregate waste material into an airflow;
passing the aggregate waste material in the airflow through a venturi to pulverize the aggregate waste material;
passing the aggregate waste material through an electric field configured to electrically charge plastic material in the aggregate waste material; and
collecting the charged plastic material on a grounded collection component.

2. The method of claim 1, further comprising an air turbine, in communication with the venturi, generating the airflow.

3. The method of claim 2, wherein the air turbine is coupled to a diverging portion of the venturi.

4. The method of claim 2, further comprising:
placing an inlet tube in fluid communication with the venturi and the air turbine so that the airflow passes through the inlet tube; and
passing the aggregate waste material through the inlet tube.

5. The method of claim 4, further comprising configuring an upper portion of the inlet tube with an elongated opening to allow introduction of aggregate waste material into the inlet tube.

6. The method of claim 1, further comprising shredding the aggregate waste material before introducing the aggregate waste material into the airflow.

7. The method of claim 6, wherein the aggregate waste material is shredded such that individual particles are less than about 2 inches across.

8. The method of claim 1, wherein the grounded collection component comprises a rotatable drum.

9. The method of claim 8, further comprising generating an airstream to remove the plastic material from the drum.

10. The method of claim 8, further comprising using a wiper blade to remove the plastic material from the drum.

11. The method of claim 1, wherein passing the aggregate waste material through the venturi includes drying the aggregate waste material.

12. The method of claim 1, further comprising passing the aggregate waste material through one or more shockwaves in connection with the venturi and the airflow.

13. The method of claim 1, wherein the airflow has a velocity greater than Mach 1.

14. The method of claim 1, wherein the airflow has a velocity of approximately Mach 1.

15. The method of claim 1, wherein passing the aggregate waste material through an electric field includes passing the aggregate waste material by a charging grid.

16. The method of claim 15, wherein passing the aggregate waste material through an electrical field further includes dropping the aggregate waste by the charging grid.

17. The method of claim 1, further comprising a material feed component conveying the pulverized aggregate waste material from the venturi to a position proximate to the electric field generated by a charging grid.

18. The method of claim 17, wherein the material feed component comprises a conveyor belt configured to drop the pulverized aggregate waste material pass the charging grid.

19. The method of claim 18, wherein the grounded collection component comprises a drum and further comprising coupling the drum to the conveyor belt to maintain relative rotation speeds.

20. A system for separating plastic from aggregate waste material, comprising:
an airflow generator;
a venturi in fluid communication with the airflow generator;
a charging grid configured to generate an electrical field around passing aggregate waste material; and
a grounded collection component configured to attract plastic material charged by the charging grid.

21. The system of claim 20, wherein the airflow generator is coupled to a diverging portion of the venturi.

22. The system of claim 20, further comprising an inlet tube in fluid communication with the venturi and the airflow generator.

23. The system of claim 20, wherein the inlet tube includes an elongated opening disposed on an upper portion of the inlet tube and configured to allow introduction of the aggregate waste material into the inlet tube.

24. The system of claim 20, further comprising a shredder configured to shred the aggregate waste material before introducing the aggregate waste material into the airflow.

25. The system of claim 24, wherein the shredder is configured to shred the aggregate waste material into individual particles less than about 2 inches across.

26. The system of claim 20, wherein the grounded collection component comprises a rotatable drum.

27. The system of claim 26, further comprising a wiper blade to remove the plastic material from the drum.

28. The system of claim 26, further comprising an air nozzle configured to direct an airstream to remove the plastic material from the drum.

29. The system of claim 20, wherein the airflow generator is configured to generate an airflow with a velocity greater than Mach 1.

30. The system of claim 20, wherein the airflow generator is configured to generate an airflow with a velocity of approximately Mach 1.

31. The system of claim 20, further comprising a material feed component configured to convey aggregate waste material passed through the venturi to a position proximate to the charging grid.

32. The system of claim 31, wherein the material feed component comprises a conveyor belt configured to drop the aggregate waste material pass the electrical field generated by the charging grid.

33. The system of claim 31, wherein the material feed component comprises a conveyor belt and the grounded collection component comprises a drum, wherein the conveyor belt and drum are coupled to one another to maintain relative rotation speeds.
